(19) United States
(12) Patent Application Publication
(10) Pub. No.: US 2026/0348757 A1
(43) Pub. Date: Nov. 5, 2026

(54) AUTOMATIC TARE-REMOVAL AND NET-WEIGHT CALCULATION METHOD AND SYSTEM BASED ON VISUAL RECOGNITION

(71) Applicant: Shenzhen Matrix Quest Technology Co., Ltd., Shenzhen (CN)

(72) Inventor: LIHAO ZHONG, Guangzhou (CN)

(21) Appl. No.: 19/707,926

(22) Filed: Jun. 15, 2026

(30) Foreign Application Priority Data
Jun. 6, 2026 (CN) 202610817198.5

(51) Int. Cl. G01G 23/16; G06V 10/82

(52) U.S. Cl. CPC G01G 23/16; G06V 10/82

(57) ABSTRACT

An automatic tare-removal and net-weight calculation method based on visual recognition is provided. The method comprises: acquiring weight data of a target object and performing stability analysis; triggering image acquisition when the weight data is stable; performing local mode recognition on the acquired image to determine whether the object is a spool; uploading the image to a server for spool category recognition to obtain a category identifier if the object is a spool, or directly outputting the weight data if the object is an ordinary object; querying the spool database for the corresponding tare data based on the category identifier; calculating the net weight using the weight data and the tare data; and outputting and displaying the net weight. The method allows fully automatic net-weight determination without manual tare lookup or subtraction, thus improving efficiency and reliability.

### CROSS-REFERENCE TO RELATED APPLICATIONS

This application claims priority to Chinese Patent Application No. 202610817198.5, filed on Jun. 6, 2026, which is hereby incorporated by reference in its entirety.

### TECHNICAL FIELD

The present application relates to the technical field of weighing, and in particular to an automatic tare-removal and net-weight calculation method and system based on visual recognition, a computer device, and a storage medium.

### BACKGROUND

With the development of FDM (Fused Deposition Modeling) 3D printing technology, filament materials are typically stored on spools. During printing, users need to know the remaining net weight of filament on the spool to determine whether it is sufficient to complete a print job. Existing weighing devices measure only the total weight of the spool and the filament, and the tare weight of the spool varies depending on brand and model. Users must manually look up the spool's tare weight and calculate the net weight by subtraction.

However, this manual lookup and calculation process is cumbersome and inefficient.

### SUMMARY

The present disclosure provides a method, system, computer device, and computer-readable storage medium for automatic tare removal and net weight calculation based on visual recognition, so as to automatically identify a spool object and calculate a net weight without requiring a user to manually look up tare data or perform subtraction.

In one aspect, a method includes acquiring weight data of a target object, performing stability analysis on the weight data, and generating a trigger signal when the weight data is determined to be in a stable state; acquiring an image of the target object in response to the trigger signal; performing local mode recognition on the acquired image to determine whether the target object is a spool object; when the target object is determined to be the spool object, uploading the image to a server side so that the server side performs spool category recognition and obtains a corresponding category identifier; when the target object is determined to be an ordinary object, directly outputting the weight data as a weighing result; querying tare data corresponding to the category identifier in a spool database; calculating a net weight result according to the weight data and the tare data; and outputting and displaying the net weight result.

In some embodiments, the stability analysis includes collecting a plurality of consecutive sampling points of the weight data by using a sliding window, calculating a peak-to-peak value of the weight data in the sliding window, and calculating a deviation between a latest sampling point in the sliding window and an average value of remaining sampling points in the sliding window. When the peak-to-peak value is less than a preset peak-to-peak threshold and the deviation is less than a preset deviation threshold, the weight data is determined to be in the stable state.

In some embodiments, performing the local mode recognition includes inputting the acquired image into a lightweight convolutional neural network model to obtain a probability value that the target object is the spool object. The probability value is compared with a preset high threshold and a preset low threshold. When the probability value is greater than or equal to the preset high threshold, the target object is determined to be the spool object. When the probability value is less than or equal to the preset low threshold, the target object is determined to be the ordinary object. When the probability value is between the preset low threshold and the preset high threshold, a plurality of frames of images are continuously acquired and respectively input into the lightweight convolutional neural network model, and an average value of probability values output from the plurality of frames is compared again with the preset high threshold and the preset low threshold. If the average value remains between the preset low threshold and the preset high threshold, the image is uploaded to the server side.

In some embodiments, when the server side performs spool category recognition, the server side synchronously outputs a recognition confidence corresponding to the category identifier. When a highest recognition confidence output by the server side is lower than a preset confidence threshold, the terminal receives a plurality of candidate categories and a corresponding probability distribution returned by the server side, queries tare data corresponding to each candidate category in the spool database, and calculates the net weight result by using a weighted fusion model.

In some embodiments, the weighted fusion model is represented as follows:

$${W}_{net} = {W}_{total} - {\sum }_{i = 1}^{N} {β}_{i} \cdot {W}_{tare , i}$$

$${\sum }_{i = 1}^{N} {β}_{i} = 1$$

where Wₙₑₜ represents the net weight result, Wₜₒₜₐₗ represents the weight data, N represents the number of candidate categories, W_{tare,i} represents tare data of an i-th candidate category, and βᵢ represents a fusion weight of the i-th candidate category

In some embodiments, the fusion weight is determined by constructing a prior probability model based on user historical usage records, the historical usage records including spool categories historically used by the user and occurrence frequencies thereof, calculating a weighted weight for each historical usage record according to time recency and recognition confidence; calculating a prior probability according to historical weighted strength of each spool category; and calculating the fusion weight by multiplying and normalizing the prior probability and category confidence output by the server side.

In some embodiments, the fusion weight is represented as follows:

$${β}_{i} = \frac{{p}_{i}^{γ} \cdot {q}_{i}^{δ}}{{\sum }_{j = 1}^{N} {p}_{j}^{γ} \cdot {q}_{j}^{δ}}$$

where qᵢ represents a prior probability of an i-th spool category, pᵢ represents category confidence corresponding to the i-th spool category, and γ and δ represent preset weight adjustment parameters.

In some embodiments, calculating the net weight result includes querying an additional structure compensation weight corresponding to the spool category and obtaining the recognition confidence corresponding to the category identifier synchronously output when the server side performs spool category recognition. The net weight result is calculated by using a compensation formula represented as follows:

$${W}_{net}^{⋆} = {W}_{total} - {W}_{tare} - {W}_{extra} + α$$

where Wₜₐᵣₑ represents the tare data, Wₑₓₜᵣₐ represents the additional structure compensation weight, and α represents a correction parameter. The correction parameter includes at least one of a weighing stability correction term, an environmental compensation term, and a recognition-confidence correction term, and the recognition-confidence correction term has an inverse relationship with the recognition confidence.

In some embodiments, after the target object is determined to be the spool object, a spool mode is locked while the current target object remains stable. When it is detected that the target object is removed from a weighing platform or a variation amount of the weight data exceeds a preset variation threshold, the mode lock is released and the stability analysis of the weight data is performed again. When server-side recognition fails or network communication is abnormal, the method automatically falls back to an ordinary weighing mode and directly outputs the weight data.

In another aspect, a system includes a data acquisition module configured to acquire the weight data, perform the stability analysis, and generate the trigger signal; an image acquisition module configured to acquire the image of the target object in response to the trigger signal; a local mode recognition module configured to perform the local mode recognition, determine whether the target object is the spool object, upload the image to the server side when the target object is the spool object, and directly output the weight data as the weighing result when the target object is the ordinary object; a net weight calculation module configured to query the tare data in the spool database according to the category identifier and calculate the net weight result according to the weight data and the tare data; and an output display module configured to output and display the net weight result.

The above method and system automatically complete, after the target object is placed on the weighing platform, stability detection, image acquisition, local preliminary recognition, server-side spool category recognition, tare-data query, net weight calculation, and result display. Accordingly, the user does not need to manually query tare data or perform subtraction, weighing operations are simplified, and the efficiency and automation degree of obtaining net weight are improved. At the same time, when the local mode recognition determines that the target object is an ordinary object, the weight data is directly output as the weighing result, so that the device remains compatible with ordinary weighing requirements for different types of objects.

### BRIEF DESCRIPTION OF DRAWINGS

FIG. 1 is a schematic diagram illustrating an application environment of a vision-recognition-based automatic tare-removal net weight calculation method according to one embodiment of the present disclosure.

FIG. 2 is a flowchart illustrating a vision-recognition-based automatic tare-removal net weight calculation method according to one embodiment of the present disclosure.

FIG. 3 is a flowchart illustrating a stability analysis process according to one embodiment of the present disclosure.

FIG. 4 is a structural block diagram of a vision-recognition-based automatic tare-removal net weight calculation system according to one embodiment of the present disclosure.

FIG. 5 is a block diagram illustrating an internal structure of a computer device according to one embodiment of the present disclosure.

### DESCRIPTION OF EMBODIMENTS

To make the objectives, technical solutions, and advantages of the present disclosure clearer, the present disclosure is described below in further detail with reference to the drawings and embodiments. The specific embodiments described herein are used only for explaining the present disclosure and are not intended to limit the present disclosure. For ease of understanding, the background of the technical solution involved in the embodiments of the present disclosure is first described.

In the field of FDM (Fused Deposition Modeling) 3D printing, filament is generally wound in a filament form on a spool for use by a printer. Before starting a print job, a user needs to know the net weight of the remaining filament on the spool so as to determine whether the remaining filament is sufficient to complete a model to be printed. Existing weighing devices, such as electronic scales, can directly measure the total weight of an object placed thereon. However, because the spool itself has a tare weight, and tare weights vary among brands, models, specifications, and materials, the output of the weighing device is the total weight of the spool and the filament rather than the net filament weight that the user actually cares about. To obtain the net weight, the user typically needs to query or remember a tare value of the current spool, for example from product instructions, an official website, or past use experience, and then manually subtract the tare value from the total weight. Such a process depends on manual operation, is cumbersome and time-consuming, and is particularly inconvenient when different spools are frequently replaced. It may also cause an inaccurate net-weight result due to an incorrect lookup or calculation error. Therefore, automatically removing the spool tare weight during weighing and directly outputting the filament net weight is a technical problem to be solved in this field.

The embodiments of the present disclosure provide an automatic tare-removal and net-weight calculation method and system based on visual recognition, a computer device, and a storage medium.

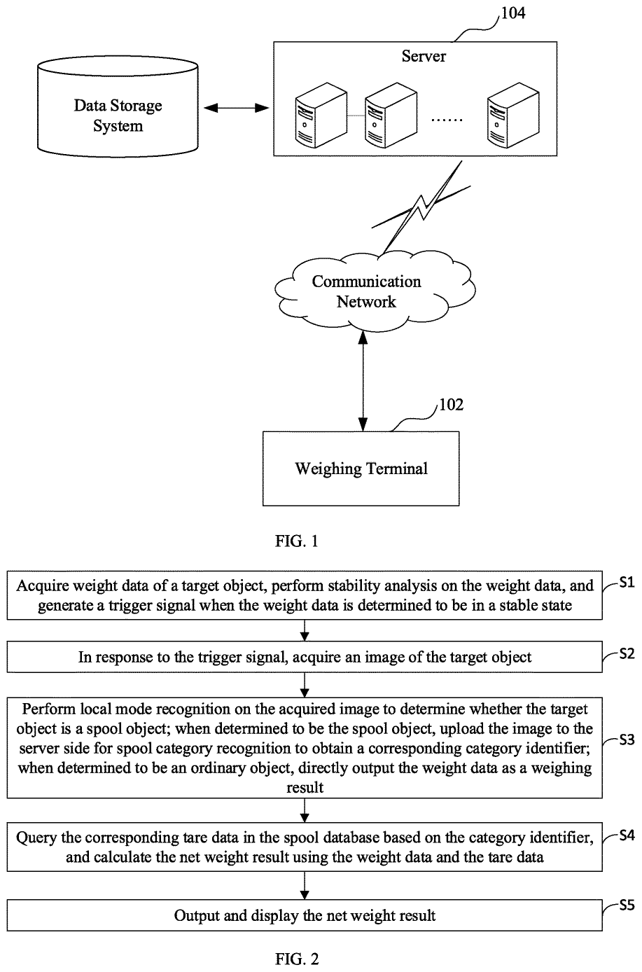

The method provided in the embodiments may be applied to the application environment shown in FIG. 1. A weighing terminal 102 communicates with a server 104 through a network. A data storage system may store data to be processed by the server 104, such as a spool tare database and historical usage records. The data storage system may be integrated in the server 104, or may be deployed in a cloud server or another network server. In operation, the weighing terminal 102 acquires weight data of a target object, performs stability analysis, triggers image acquisition when the weight is stable, performs local mode recognition to determine whether the target object is a spool object, uploads an image to the server 104 when the target object is determined to be a spool object, and receives from the server 104 a spool category identifier and confidence. The weighing terminal 102 then calculates and outputs a net-weight result based on the queried tare data and the total weight. The weighing terminal 102 may be, but is not limited to, an intelligent scale, an intelligent weighing device, a dedicated 3D printing filament scale, or another Internet-of-Things device integrating a weighing sensor and a camera. The server 104 may be implemented by an independent server or a server cluster.

In a first aspect, during weighing, a user places a target object on a weighing platform. The target object may be a spool loaded with filament or an ordinary object, such as a book or tool. In the prior art, a weighing device only outputs a total weight and cannot distinguish the type of the target object or automatically remove tare. In one embodiment, as shown in FIG. 2, the method is described below by taking the weighing terminal 102 in FIG. 1 as an example.

Step S1: weight data of the target object is acquired, stability analysis is performed on the weight data, and a trigger signal is generated when the weight data is determined to be in a stable state.

Specifically, acquiring the weight data means continuously obtaining a mass signal of the target object placed on the weighing platform through a weighing sensor. In one example, the weighing sensor is a resistance-strain weighing sensor, and an analog voltage signal output thereby is converted into a digital weight value by a 24-bit analog-to-digital converter. A sampling period may be 100 milliseconds, namely 10 Hz. A range of the sensor may be selected according to actual needs, for example a maximum weighing range of 5000 grams and a precision of 0.1 gram. The embodiments are not limited to a particular sensor model.

The stability analysis refers to statistically processing a plurality of continuously collected weight values to determine whether the target object has been stably placed on the weighing platform, thereby avoiding a subsequent operation being triggered while the object is shaking or not yet placed in position. The stability analysis may adopt any suitable existing method, for example calculating a difference between a maximum value and a minimum value of consecutive sampling points, calculating a standard deviation of sampling data, or detecting a deviation between the latest sampling point and a historical average. When the weight data is determined to be stable, a trigger signal is generated as a start command for subsequent image acquisition, so that sensing and photographing can be triggered without a manual button. The trigger signal may be generated in the form of a level change or an interrupt.

Step S2: in response to the trigger signal, an image of the target object is acquired.

Specifically, after the trigger signal is received, an image acquisition module, such as a camera module, is controlled to photograph the target object within a weighing region on the weighing platform. Acquiring the image may include controlling an included angle between an optical axis of the image acquisition module and a normal line of a bearing surface of the weighing platform to be less than a preset angle, so as to capture a top-view image of the target object; setting an installation height between the image acquisition module and the bearing surface to a preset installation height according to a maximum outer diameter of the spool object, a field of view of the image acquisition module, and an acquired-image size, so that when the target object is a spool object, an outer contour of the spool object completely falls within the acquired image; and causing a ratio of a projected area of the outer contour of the spool object in the acquired image to a total area of the acquired image to be greater than or equal to a preset ratio threshold.

In more detail, the image acquisition module is disposed above the weighing platform, the optical axis thereof faces the bearing region of the weighing platform, and the included angle between the optical axis and the normal line of the bearing surface is less than the preset angle, for example less than 15 degrees, 10 degrees, or 5 degrees, to obtain a top-view image of the spool object. Preferably, the optical-axis deviation is constrained within ±2.5 degrees, so as to minimize geometric distortion in the acquired image. Such a structure reduces distortion of the circular outer contour of the spool caused by oblique photographing, and improves recognition stability of structural features such as the outer rim, central hole, radial ribs, paper-core region, and label region of the spool. The installation height is determined so that, when the spool object is placed in a designated spool placement region of the weighing platform, the outer contour of the spool completely falls within the acquired image. Preferably, the installation height is 80 mm to 300 mm, and more preferably 100 mm to 220 mm. In one example, a vertical distance from the camera device to the weighing pan is 19.0 cm±3 cm. Preferably, the preset ratio threshold is 60%, 65%, 70%, or 75%; more preferably, the ratio of the projected area of the outer contour of the spool object to the total area of the acquired image is 60% to 95%, and still more preferably 70% to 90%. When the acquired image is square and the outer contour of the spool is circular or substantially circular, the outer contour of the spool may approach an inscribed circle of the square acquired image, thereby preventing clipping of the outer contour while allowing the structural features of the spool to occupy a large effective recognition region. Image acquisition may start within 50 milliseconds after the trigger signal is generated, so that the posture of the spool is not changed.

Accordingly, the installation angle, installation height, field of view, and spool placement region of the image acquisition module are jointly configured so that, after stable weighing, the spool object is imaged from a top-view direction in a complete, centered, and high-proportion manner. This improves the accuracy of spool category recognition and automatic tare-removal net-weight calculation.

Step S3: local mode recognition is performed on the acquired image to determine whether the target object is a spool object. When the target object is determined to be the spool object, the image is uploaded to a server side, namely the server 104, so that the server side performs spool category recognition to obtain a corresponding category identifier. When the target object is determined to be an ordinary object, the weight data is directly output as a weighing result.

Specifically, the weighing terminal 102 first performs preliminary analysis locally on the acquired image to distinguish whether the target object is a spool or an ordinary object. This step may be implemented by a lightweight algorithm, for example by rule-based determination using image geometric features, such as detecting whether a circular or annular structure exists in the image, or by a lightweight machine-learning model. Because this step runs on the weighing terminal 102 and does not require network communication, it has a fast response speed and can perform basic determination even when no network is available. If the target object is determined to be an ordinary object, the currently acquired weight data is directly output as the weighing result without any tare-removal operation, and the weighing terminal 102 functions as an ordinary electronic scale.

If the local mode recognition determines that the target object is a spool, the acquired image data is sent to the server side through the network. The network communication protocol may be HyperText Transfer Protocol or Message Queuing Telemetry Transport. A higher-precision deep neural network model may be deployed on the server side to accurately classify the brand and model of the spool. After recognition is completed, the server side returns a category identifier, for example “Spool_ManufacturerA_Model_1 kg”. The server side may also synchronously output a recognition confidence corresponding to the category identifier, for example 0.92. The recognition confidence may be a floating-point value between 0 and 1 and indicates the certainty of the model regarding the classification result. For an image having low recognition confidence, the server side may return a plurality of candidate categories and a corresponding probability distribution, for example the top three most likely categories and their probability values of 0.6, 0.3, and 0.1.

Step S4: tare data corresponding to the category identifier is queried in a spool database, and a net-weight result is calculated according to the weight data and the tare data.

Specifically, the weighing terminal 102 retrieves the category identifier in a pre-established spool tare database. The database may be stored in a key-value form, in which a key is a category identifier and a value is a corresponding tare value in grams. The tare value may be obtained in advance by weighing an empty spool using a high-precision electronic scale. The database may be stored at the server side and queried by the weighing terminal 102 through the network, or frequently used data may be periodically synchronized to a local cache of the terminal to reduce network latency. The spool database may store category data, structural data, tare data, and correction data related to 3D printing filament spools, and may include at least one of: a spool category identifier; spool brand information; spool model information; spool material type, such as a transparent spool, paper spool, or plastic spool; empty-spool weight; paper-core weight; additional structure compensation weight; spool outer diameter; spool inner-hole size; spool width; spool color information; structural feature information including an outer rim, central hole, radial ribs, paper-core region, and label region; a structural feature vector for image recognition; historical correction weights for different batches or sources; actual tare data confirmed by the user; recognition sample images or training sample data corresponding to the spool category; and an entry year and date.

In particular, the corresponding hardware product, such as the automatic tare-removal and net-weight calculation system based on visual recognition, is not a product that is developed once and sold for a long time without maintenance. Instead, FDM 3D printing filament spools available in the market need to be continuously entered and maintained, and the algorithm status needs to be tracked. This differs from conventional visual recognition systems directed to relatively common objects, such as supermarket goods, vegetables, and fruits.

Then, the currently measured weight data, namely the total weight of the spool and the filament, is subtracted by the queried tare data to obtain the filament net weight. In a basic implementation, the net-weight calculation result is as follows: net weight=total weight−tare weight.

When the server side cannot determine the spool category, the recognition confidence is below a preset threshold, the server side returns a plurality of candidate categories, the user considers the net-weight result abnormal, or the user actively corrects the spool category or tare data, the weighing terminal 102 may provide an interactive button, for example an “incorrect recognition, upload for learning” button on the display. After the user selects the button, the system receives at least one of the current spool image, the current weight data, a candidate-category selection result, a user-confirmed spool category, user-input or user-confirmed tare data, device identification information, and time information.

The server side performs at least one of data correction, sample annotation, spool database updating, and recognition-model optimization training based on the uploaded data. The server side may update the tare data, additional structure compensation weight, structural feature information, or recognition sample set corresponding to the spool category based on user-confirmed results, manual-review results, or statistical results of samples uploaded by multiple users. A recognition-failed or low-confidence sample may be added to a to-be-annotated sample library and, after manual confirmation or rule verification, used to update the spool database. The sample may also be used as a subsequent training sample to optimize the server-side spool category recognition model or the local spool/non-spool recognition model.

By setting a continuously updatable spool database and a user correction upload mechanism, the present disclosure can continuously expand identifiable spool brands, models, and structural types after the device leaves the factory, thereby reducing recognition failure caused by new brands, transparent spools, paper spools, similar structural spools, or missing database entries. The accuracy and long-term adaptability of automatic tare-removal net-weight calculation are therefore improved. This mechanism differs from ordinary visual weighing devices that rely only on a fixed commodity database or a fixed recognition model, and provides a user-feedback-driven continuous learning capability that is not available in conventional one-way AI image recognition systems.

Step S5: the net-weight result is output and displayed.

Specifically, the calculated net weight may be presented to the user through a display. The display may be a 240×320 color liquid-crystal display. The display content may include only the net-weight result, for example “Net weight: 856 g”, or may simultaneously display the total weight and tare weight for user verification. The display content may be refreshed every 0.5 seconds to ensure real-time performance.

Through the above steps, the user only needs to place the target object on the weighing platform, and the weighing terminal 102 automatically completes stability detection, image acquisition, local preliminary determination, upload recognition, tare query, net-weight calculation, and display, without manual operation or table lookup and calculation. When an ordinary object is placed, the weighing terminal 102 directly outputs the total weight and maintains an ordinary weighing function. When a spool is placed, the weighing terminal 102 automatically outputs the filament net weight. This solves the problem that manual tare lookup and manual calculation in the prior art are inefficient, simplifies weighing operation, and improves the automation level of obtaining net weight.

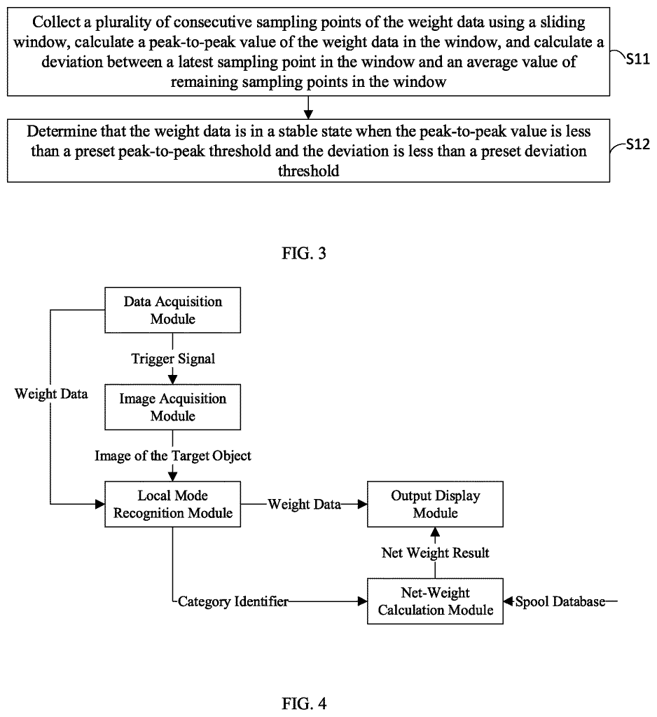

During weighing, accurately determining whether the target object has been stably placed is important for avoiding false triggering and ensuring measurement accuracy. If the stability determination is too sensitive, image acquisition may be triggered while the object is still shaking, causing image blur or recognition error. If the determination is too insensitive, the user may need to wait too long. Therefore, in one embodiment, as shown in FIG. 3, the stability analysis includes the following steps.

Step S11: a plurality of consecutive sampling points of the weight data are collected by using a sliding window, a peak-to-peak value of the weight data in the sliding window is calculated, and a deviation between the latest sampling point in the sliding window and an average value of the remaining sampling points is calculated.

Step S12: when the peak-to-peak value is less than a preset peak-to-peak threshold and the deviation is less than a preset deviation threshold, the weight data is determined to be in the stable state.

In this embodiment, the sliding window is a fixed-length data queue that stores a plurality of most recently acquired weight data points. In this embodiment, a window length L is set to 9, and a sampling period T_{S} is set to 100 milliseconds. Thus, the time span covered by the window is L×T_{S}=0.9 seconds. Each time new weight data is acquired, the new data is pushed into the tail of the window and the oldest data is removed from the queue, thereby implementing sliding updating. The new sample and the window data set may be represented as follows, where k is the current sampling index:

{x_{k-L+1},x_{k-L+2}, . . . ,xₖ},x_{new}=xₖ

The peak-to-peak value of the weight data in the window is calculated as a difference between the maximum weight value and the minimum weight value in the window, and may be represented as follows. The value reflects the fluctuation amplitude of the weight data in the window. When the target object is stably placed, the weight data tends to be constant and the peak-to-peak value is small.

PP=xₘₐₓ−xₘᵢₙ

The deviation between the latest sampling point and the average value of the remaining sampling points in the window is calculated by first calculating an arithmetic average of the L−1 sampling points other than the last sampling point, and then calculating an absolute difference between the latest sampling point and the average value. The deviation may be represented as follows and is used to detect whether the latest data deviates from the historical trend, thereby quickly capturing the stable moment after placement is completed.

$${x}_{rest} = \frac{1}{L - 1} {\sum }_{i = k - L + 1}^{k - 1} {x}_{i}$$

$${Deviation}_{k} = \vert {x}_{k} - {\ddot{x}}_{rest} \vert$$

The preset peak-to-peak threshold and the preset deviation threshold are values preset according to the precision of the weighing sensor and actual application requirements. In this embodiment, the preset peak-to-peak threshold converted to the mass domain is equivalent to 0.5 gram, and the preset deviation threshold is equivalent to 0.25 gram. When the peak-to-peak value is less than 0.5 gram and the deviation is less than 0.25 gram, the weight data is determined to be stable. A stable-duration condition may also be added, for example requiring the stable state to last for at least 1 second, namely ten consecutive sampling windows satisfy the condition, so that the object is fully stationary.

Through the above sliding-window analysis method, a transition point from dynamic change to static stability of the weight data can be accurately identified. The trigger signal is generated at an accurate timing, false triggering caused by shaking is avoided, and response speed is maintained. Thus image acquisition can be performed immediately after the object becomes stable, and the success rate and reliability of subsequent recognition are improved.

In the local mode recognition stage, a method is needed that can operate in real time on a resource-limited terminal device and accurately distinguish a spool from an ordinary object. A conventional deep-learning model has a large computation amount and is unsuitable for deployment on a low-cost embedded chip, while a pure geometric rule, such as detecting an annular object, is susceptible to background interference. Therefore, in one embodiment, the local mode recognition includes inputting the acquired image into a lightweight convolutional neural network model to obtain a probability value that the target object is a spool object; comparing the probability value with a preset high threshold and a preset low threshold; determining the target object to be the spool object when the probability value is greater than or equal to the high threshold; determining the target object to be an ordinary object when the probability value is less than or equal to the low threshold; and, when the probability value is between the low threshold and the high threshold, continuously acquiring multiple frames of images, inputting the frames into the lightweight convolutional neural network model, and comparing an average value of output probability values with the two thresholds again. If the average value remains between the low threshold and the high threshold, the image is uploaded to the server side.

The lightweight convolutional neural network model may be a convolutional neural network having a small number of parameters and a low computation amount. The model may be trained in advance on the server side using a large number of labeled images, and trained model parameters are then deployed on the terminal device. In one implementation, the model uses a grayscale image having a size of 120×120 pixels and one channel as input. The model may include: an input layer receiving a 120×120×1 grayscale image tensor; a first convolutional layer using sixteen 3×3 convolution kernels with a stride of 2 and outputting 60×60×16 feature maps, followed by a ReLU activation function; a second convolutional layer using twenty-four 3×3 kernels with a stride of 2 and outputting 30×30×24 feature maps, followed by ReLU; a third convolutional layer using thirty-two 3×3 kernels with a stride of 2 and outputting 15×15×32 feature maps, followed by ReLU; a fourth convolutional layer using forty-eight 3×3 kernels with a stride of 2 and outputting 8×8×48 feature maps, followed by ReLU; a fifth convolutional layer using sixty-four 3×3 kernels with a stride of 1 and same padding, outputting 8×8×64 feature maps, followed by ReLU; a global average pooling layer that performs global average pooling on the 8×8×64 feature maps in each channel to output a 64-dimensional vector; a first fully connected layer mapping the 64-dimensional vector to a 16-dimensional vector, followed by ReLU; a second fully connected output layer mapping the 16-dimensional vector to a 2-dimensional vector; and a Softmax layer or a Sigmoid layer that normalizes the output to obtain the probability value that the target object is a spool object. The probability value is in the range of 0 to 1, where a value closer to 1 indicates that the model is more certain that the current object is a spool, and a value closer to 0 indicates that the model is more certain that the current object is an ordinary object.

The total number of parameters of the model may be about 50,000 and may be controlled within a range of 20K to 100K. Before model training, a large number of image data are collected and labeled. The training data set may include about 300 to 500 spool categories, with 50 to 200 images for each category, and a comparable number of ordinary-object images such as books, stationery, and tools. The images are acquired under different lighting conditions, different photographing angles, different backgrounds, and different remaining filament amounts to enhance generalization. All images are scaled and converted into 120×120 grayscale images. A label of each image is a binary label, in which 1 indicates a spool and 0 indicates an ordinary object.

Model training is performed at the server side by supervised learning. The loss function may be binary cross entropy. The optimizer may be AdamW, an initial learning rate may be 10\hat{ }-3, the number of training epochs may be 100, and the batch size may be 64. Data augmentation techniques, such as random rotation, random brightness adjustment, and random scaling, may be used during training. After training is completed, model weights are saved. The trained model may be compressed by 8-bit integer quantization and deployed to the terminal device. The quantized model size may be about 50 KB to 300 KB. A lightweight inference engine runs on the terminal device and loads the quantized model. For a 120×120 grayscale input image, inference time on a typical embedded platform such as an ESP32-S3 with a main frequency of 240 MHz may be about 80 to 150 milliseconds. The inference process outputs a floating-point value in the range of 0 to 1.

The preset high threshold and the preset low threshold are two decision boundary values, and may be set according to the confidence distribution of the model on a validation set and according to tolerance for false positives and false negatives in actual use. Generally, the high threshold may be set between 0.7 and 0.9, and the low threshold may be set between 0.1 and 0.3. In this embodiment, the high threshold is set to 0.8 and the low threshold is set to 0.2. When the probability satisfies the high threshold condition, the model determines with high confidence that the target object is a spool and directly executes the spool processing flow. When the probability satisfies the low threshold condition, the model determines with high confidence that the target object is an ordinary object and directly outputs the total weight. When the probability is between the two thresholds, the model is uncertain. In this case, K frames of images, for example K=3 frames, are continuously acquired and input into the same model, K probability values are obtained, and their average is calculated. If the average still remains between the two thresholds, the uncertainty is considered not to be caused only by random fluctuation, and the image is uploaded to the server side. If the average is greater than or equal to the high threshold or less than or equal to the low threshold, processing is performed according to the corresponding classification result.

Through the multiple-frame fusion and dual-threshold decision mechanism, fast response is ensured in high-confidence cases without uploading to the server, misclassification in low-confidence cases is reduced, unnecessary dependence on the server is avoided when the network is unstable, and local computing resources and cloud recognition capability are optimally allocated, thereby improving overall robustness and recognition accuracy.

When the server side performs spool category recognition, recognition confidence may be insufficient due to incomplete training data coverage, poor lighting, spool wear, or other factors. In such a case, directly using the tare data corresponding to the highest-confidence result may introduce a relatively large error. Therefore, in one embodiment, when the server side performs spool category recognition, the server side synchronously outputs recognition confidence corresponding to the category identifier. When a highest recognition confidence output by the server side is lower than a preset confidence threshold, the terminal receives a plurality of candidate categories and a corresponding probability distribution returned by the server side, queries tare data corresponding to the candidate categories in the spool database, and calculates the net-weight result by using a weighted fusion model:

$${W}_{net} = {W}_{total} - {\sum }_{i = 1}^{N} {β}_{i} \cdot {W}_{tare , i}$$

where Wₙₑₜ represents the net-weight result, Wₜₒₜₐₗ represents the weight data, N represents the number of candidate categories, W_{tare,i} represents the tare data of an i-th candidate category, βᵢ represents a fusion weight of the i-th candidate category, and the fusion weights satisfy the following normalization condition

$${{\sum }_{i = 1}}^{N} {β}_{i} = 1$$

In implementation, the preset confidence threshold may be denoted as τ and may be calibrated according to the relationship between confidence and classification accuracy of the server-side deep neural network model on a validation set. After model training, validation-set images are inferred and classification accuracy in different confidence intervals is counted. Model output confidence is generally positively correlated with classification accuracy. The threshold should balance single-category recognition reliability and the necessity of multi-candidate fusion. In this embodiment, the preset confidence threshold is 0.7. When the highest confidence is lower than 0.7 on the validation set, the probability of an incorrect prediction increases significantly, and the multi-candidate weighted fusion mechanism is triggered. In high-precision applications, the threshold may be increased to 0.8. When the highest class probability output by the server-side deep neural network model is lower than 0.7, the server side may return a candidate list including the top N categories having the highest probabilities and their probabilities. In actual use, N may be 3 or 5. For example, the candidate list returned by the server side may include category A with probability 0.55, category B with probability 0.30, and category C with probability 0.15, and other categories have probabilities below 0.05.

After receiving the candidate-category list, the terminal queries the corresponding tare value for each candidate category in the spool database. A weighted tare value is then calculated according to the fusion weight of each candidate category, and the net weight is obtained by subtracting the weighted tare value from the total weight. In an initial setting, the fusion weight for each candidate category may simply be set to the probability returned by the server side. Since the sum of the probabilities is equal to one, this setting naturally satisfies the weight normalization condition.

For example, assuming that the total weight is 1250 grams, the tare weights of candidate categories A, B, and C are 200 grams, 210 grams, and 190 grams, respectively, and the corresponding probabilities are 0.55, 0.30, and 0.15, respectively, the weighted tare value may be calculated as follows:

W_{tare,weighted}=0.55×200+0.30×210+0.15×190=201.5 grams

Accordingly, the net weight obtained by the weighted fusion model may be calculated as follows:

W_{net,weigted}=1250−W_{tare,weighted}=1250−201.5=1048.5 grams

If the highest-probability candidate category A is directly selected without weighted fusion, the net weight would be calculated as follows:

W_{net,A}=1250−200=1050 grams

The difference between the direct-selection result and the weighted-fusion result may be calculated as follows:

ΔW=W_{net,A}−W_{net,weighted}=1050−1048.5=1.5 grams

Therefore, the weighted fusion method smooths the influence of different candidate tare values, reduces an error that may be caused by incorrectly selecting a single candidate category, and improves the accuracy and robustness of the net-weight calculation.

Different users often have personalized spool usage patterns, for example a user may use a particular brand of spool for a long time. Incorporating the user historical usage habit into the weighted fusion model may further improve recognition decision accuracy and reduce net-weight error caused by visual misclassification. Therefore, in one embodiment, fusion weights are determined by constructing a prior probability model based on user historical usage records, the historical usage records including spool categories historically used by the user and occurrence frequencies thereof, calculating a weighted weight for each historical usage record according to time recency and recognition confidence; calculating a prior probability according to historical weighted strength of each spool category; and calculating the fusion weight by multiplying and normalizing the prior probability and category confidence output by the server side:

$${β}_{i} = \frac{{p}_{i}^{γ} \cdot {q}_{i}^{δ}}{{\sum }_{j = 1}^{N} {p}_{j}^{γ} \cdot {q}_{j}^{δ}}$$

where qᵢ represents a prior probability of an i-th spool category, pᵢ represents category confidence corresponding to the i-th spool category, and γ and δ represent preset weight adjustment parameters.

The user historical usage records are a data set of past weighing behavior stored on the terminal device or the server side. Each record may include a spool category identifier c, such as “ManufacturerA_Model1kg”, a recognition timestamp t represented as a Unix timestamp accurate to seconds, recognition confidence s output by the server side, and a user-feedback mark r. The user-feedback mark may initially be 0, and may be set to 1 when the user later manually corrects the recognition result.

For each historical record h, a weighted weight w is calculated to reflect both recency and reliability. The calculation formula is as follows:

w=exp(−λ·Δt)·(a·s+b·g(r))

where Δt is a time difference between the current time and the historical-record time in days; λ is a time decay coefficient and may be 0.1, so that the weight decays to about one half in approximately 7 days; s is the recognition confidence of the historical record; r is the user-feedback mark; g(r) is a feedback function, where g(0)=0 and g(1)=1; and a and b are preset weight parameters. In this embodiment, a=0.8 and b=0.2, and a+b=1. If the user has never corrected the record, the feedback term is zero and the weight is determined only by confidence and time decay.

The historical weighted strength of each spool category is calculated by summing the weighted weights of all historical records belonging to that category. Denoting the strength of category Cₖ as Sₖ, it is calculated as the sum of the weighted weights wₘ of all records m whose category Cₘ equals Cₖ. Here, I(⋅) is an indicator function that equals 1 if the condition holds, and 0 otherwise. The strength Sₖ is then normalized and a smoothing constant ε is added to avoid zero probability, thereby obtaining the prior probability qₖ. For example, ϵ may be set to 10⁻⁴. When historical data are insufficient, qₖ approximates a uniform distribution, ensuring initial usability. This process may be represented by the following formulas:

$${S}_{k} = {\sum }_{m} {w}_{m} \cdot l ( {c}_{m} = {C}_{k} ) , \text{} l ( \cdot ) = \{ \begin{matrix}1 , if the condition holds \\ 0 , otherwise\end{matrix}$$

$${q}_{k} = \frac{{S}_{k} + ϵ}{{\sum }_{j} {S}_{j} + ϵ}$$

When historical data are insufficient, the prior probability approximates a uniform distribution, thereby ensuring initial usability. In the multiplication-normalization process, for each candidate category returned by the server side, the visual recognition probability and the prior probability are multiplied, exponent-adjusted, and normalized to obtain the fusion weight. The parameters γ and δ respectively control the influence of visual recognition and historical prior information. In this embodiment, γ=1 and δ=1, which corresponds to simple multiplication normalization.

Using the above method, the system can automatically learn a user's individualized spool usage habits. For example, if a user's historical records indicate that category A appeared 100 times with a weighted strength S_{A}=95, category B appeared 10 times with S_{B}=9 and other categories are 0, the prior probabilities are approximately q_{A}≈0.91, q_{B}≈0.09. When the candidate list returned by the server contains A and B (categories that the user has previously used), and the visual probabilities are p_{A}=0.55 and p_{B}=0.45, the fusion weights are calculated as follows:

$$Weight fusion for category A : {β}_{A} = \frac{0.55 \times 0.91}{0.55 \times 0.91 + 0.45 \times 0.09} \approx 0.93$$

$$Weight fusion for category B : {β}_{B} = \frac{0.45 \times 0.09}{0.55 \times 0.91 + 0.45 \times 0.09} \approx 0.07$$

This result conforms to the user usage habit and improves stability of net-weight calculation. The fusion method uses user behavior data as auxiliary information and achieves personalized adaptive optimization.

In actual application, in addition to a main spool body, a spool often includes additional structures such as an inner paper core or moisture-proof packaging. These structures still exist when the spool is empty and should be counted as tare. In addition, zero drift of the weighing sensor, ambient temperature variation, and recognition confidence also affect net-weight accuracy. Therefore, in one embodiment, calculating the net-weight result includes querying an additional structure compensation weight corresponding to the spool category and obtaining the recognition confidence corresponding to the category identifier synchronously output when the server side performs spool category recognition. The net-weight result is calculated by using the following formula:

$${W}_{net}^{⋆} = {W}_{total} - {W}_{tare} - {W}_{extra} + α$$

where Wₜₐᵣₑ represents the tare data, Wₑₓₜᵣₐ represents the additional structure compensation weight, and α represents a correction parameter. The correction parameter includes at least one of a weighing-stability correction term, an environmental compensation term, and a recognition-confidence correction term, and the recognition-confidence correction term has an inverse relationship with the recognition confidence.

The additional structure compensation weight refers to the weight of other disposable or separable parts on the spool other than the main reusable structure. For example, many filament spools include a hard paperboard or plastic inner ring for supporting wound filament. The inner ring is usually discarded together with the spool after the filament is used up, but its weight is added to the total weight during weighing. Since different spools may have different inner-ring weights, the value needs to be separately stored for each spool category in the tare database. The value may be obtained by weighing an empty spool including the inner ring and subtracting the weight of the spool after the inner ring is removed. For example, if an empty spool including the inner ring weighs 150 grams and the spool after removal of the inner ring weighs 140 grams, the additional structure compensation weight is 10 grams. The value may also be zero if no additional structure exists.

The correction parameter a is used to comprehensively correct various system errors and may include one or more of the following components.

A weighing-stability correction term may be calculated according to the peak-to-peak value when the weight data is stable. When the peak-to-peak value is small, the correction term approaches zero; when the peak-to-peak value is relatively large, the correction term is positive and increases the net weight to compensate for possible positive fluctuations.
An environmental compensation term may be calculated according to a temperature sensor reading T and a voltage monitoring module reading V. The compensation value can be obtained through a pre-calibrated linear function or lookup table. For example, the environmental compensation term may be calculated as follows:

Cₑₙᵥ=a·(T−T₀)+b·(V−V₀)

where:
T₀ is the calibration temperature,
V₀ is the calibration voltage,
a and b are empirical coefficients.

A recognition-confidence correction term is inversely related to the highest recognition confidence output by the server side. In one implementation, the recognition-confidence correction term C_{conf} may be calculated as follows:

C_{conf}=k′·(1−pₘₐₓ)

where k′ is a proportional coefficient, for example 100 grams, and pₘₐₓ represents the highest recognition confidence output by the server side.
When pₘₐₓ equal to 1, C_{conf} is zero, as follows:

C_{conf}=k′·(1−1)=0

When pₘₐₓ is equal to 0.5 and k′ is 100 grams, C_{conf} is 50 grams, as follows:

C_{conf}=100·(1−0.5)=50 grams

That is, the net-weight result is additionally increased by 50 grams. The physical meaning is that, when the recognition result is unreliable, the system tends to conservatively output a larger net weight, namely with a smaller tare-removal amount, thereby avoiding a negative or seriously underestimated net weight caused by incorrectly subtracting an excessive tare weight.

Through the additional structure compensation weight and the correction parameter, the present embodiment can more accurately remove the weight of all non-filament portions of the spool and dynamically correct sensor and environmental errors. In particular, when the recognition confidence is not high, the inverse correction prevents excessive tare removal and improves fault tolerance and credibility of the result.

In actual use, a user may continuously weigh multiple spools or may move the same spool after placing it. If each weight change re-triggers the full recognition process, modes may switch frequently and user experience may be affected. At the same time, when the network is abnormal or the server-side recognition service is unavailable, the device should maintain a basic weighing capability and should not completely fail. Therefore, in one embodiment, after the target object is determined to be a spool object, a spool mode is locked while the current target object remains stable; when it is detected that the target object is removed from the weighing platform or a variation amount of the weight data exceeds a preset variation threshold, the mode lock is released and the stability analysis of the weight data is performed again; and when server-side recognition fails or network communication is abnormal, the method automatically falls back to an ordinary weighing mode and directly outputs the weight data.

Locking the spool mode means that, once the current target object is confirmed as a spool by local mode recognition or by local recognition in combination with server-side recognition and the spool is stably placed on the weighing platform, the system enters the spool mode. In this mode, parameters such as the currently recognized category identifier, tare data, and additional structure compensation weight are maintained unchanged. Even if the weight data changes slightly due to light user contact, for example within ±5 grams, the complete recognition process, including image uploading, is not triggered again, and only the net-weight calculation result is updated in real time. The updating method may be represented as follows:

Wₙₑₜ=Wₜₒₜₐₗ−Wₜₐᵣₑ−Wₑₓₜᵣₐ+α

where:
Wₙₑₜ is the net weight result,
Wₜₒₜₐₗ is the currently measured total weight, which dynamically changes according to the sensor readings,
Wₜₐᵣₑ is the tare weight of the object,
Wₑₓₜᵣₐ is the additional compensation weight, and
α is the correction parameter, which may include weighing-stability, environmental, and recognition-confidence correction terms.

Conditions for releasing the mode lock may include that the target object is completely removed from the weighing platform, for example when the weight data is less than a near-zero threshold such as 5 grams for more than 0.5 second, or that the variation amount of the weight data exceeds a preset variation threshold, for example 200 grams. When an absolute difference between the real-time weight and the locked-time weight, or an average weight during locking, exceeds 200 grams, it indicates that another spool may have been placed. When any of these conditions is satisfied, the system exits the spool mode, clears the currently stored category identifier and tare data, and performs stability analysis again to wait for the next target object.

When uploading the image to the server side encounters network timeout, for example no response is received for more than 5 seconds, network connection failure, or a server return code indicating recognition failure, the system automatically switches to the ordinary weighing mode. In this mode, the weighing terminal 102 no longer performs operations related to visual recognition, tare query, or additional compensation, and directly outputs the current weight data as the weighing result:

Wₙₑₜ=Wₜₒₜₐₗ

After the network is restored, the terminal may automatically retry uploading the image that failed to be recognized, and may restore the spool mode after successful recognition. A retry timer may be set to check network status every 30 seconds and resend a pending image queue when the network is available.

Through the above mode locking and fallback mechanism, stability and fault tolerance in actual use are achieved while automatic recognition capability is maintained. Mode locking avoids unnecessary repeated operations and improves user experience. Automatic fallback during network abnormality ensures the basic usability of the weighing terminal 102, so that the device can operate reliably in different network environments.

It should be understood that, although the steps in the flowcharts of the embodiments described above are shown in sequence according to arrows, these steps are not necessarily performed in the sequence indicated by the arrows. Unless explicitly stated herein, the execution of the steps is not strictly limited to the described sequence, and the steps may be performed in other sequences. At least some of the steps shown in the flowcharts may include multiple sub-steps or multiple stages. These sub-steps or stages are not necessarily completed at the same moment, and may be performed at different times. Their execution order is not necessarily sequential, and at least some of them may be performed in turn or alternately with other steps or with sub-steps or stages of other steps.

In a second aspect, based on the same inventive concept, embodiments of the present disclosure further provide a system for implementing the automatic tare-removal and net-weight calculation method based on visual recognition described above. The implementation for solving the technical problem by the system is similar to that described above for the method, and the specific limitations in the following one or more system embodiments may refer to the limitations of the method embodiments above and are not repeated in detail.

In one embodiment, as shown in FIG. 4, the system includes a data acquisition module, an image acquisition module, a local mode recognition module, a net-weight calculation module, and an output display module. The data acquisition module is configured to acquire weight data of a target object, perform stability analysis on the weight data, and generate a trigger signal when the weight data is determined to be stable. The image acquisition module is configured to acquire an image of the target object in response to the trigger signal. The local mode recognition module is configured to perform local mode recognition on the acquired image to determine whether the target object is a spool object; upload the image to the server side when the target object is determined to be a spool object, so that the server side performs spool category recognition and obtains a corresponding category identifier; and directly output the weight data as a weighing result when the target object is determined to be an ordinary object. The net-weight calculation module is configured to query corresponding tare data in the spool database according to the category identifier and calculate the net-weight result according to the weight data and the tare data. The output display module is configured to output and display the net-weight result.

In one embodiment, the data acquisition module includes a stability analysis unit. The stability analysis unit is configured to collect a plurality of consecutive sampling points of the weight data by using a sliding window, calculate a peak-to-peak value of the weight data in the sliding window, and calculate a deviation between the latest sampling point in the window and an average value of the remaining sampling points. When the peak-to-peak value is less than the preset peak-to-peak threshold and the deviation is less than the preset deviation threshold, the stability analysis unit determines that the weight data is in the stable state.

In one embodiment, the local mode recognition module includes a local mode recognition unit. The local mode recognition unit is configured to input the acquired image into the lightweight convolutional neural network model to obtain the probability value that the target object is a spool object, compare the probability value with the preset high threshold and the preset low threshold, determine the target object to be a spool object when the probability value is greater than or equal to the high threshold, determine the target object to be an ordinary object when the probability value is less than or equal to the low threshold, and when the probability value is between the two thresholds, continuously acquire multiple frames of images and respectively input the frames into the model, and compare an average probability value with the two thresholds again. If the average value still remains between the two thresholds, the image is uploaded to the server side.

In one embodiment, the net-weight calculation module includes a net-weight calculation unit. The net-weight calculation unit is configured to obtain the recognition confidence corresponding to the category identifier synchronously output when the server side performs spool category recognition. When the highest recognition confidence output by the server side is lower than the preset confidence threshold, the unit receives a plurality of candidate categories and a corresponding probability distribution returned by the server side, queries the tare data corresponding to each candidate category in the spool database, and calculates the net-weight result by using the following weighted fusion model:

$${W}_{net} = {W}_{total} - {\sum }_{i = 1}^{N} {β}_{i} \cdot {W}_{tare , i}$$

where Wₙₑₜ represents the net-weight result, Wₜₒₜₐₗ represents the weight data, N represents the number of candidate categories, W_{tare,i} represents tare data of an i-th candidate category, and βᵢ represents a fusion weight of the i-th candidate category.

In one embodiment, the net-weight calculation unit includes a fusion weight determining subunit. The fusion weight determining subunit is configured to construct a prior probability model based on user historical usage records, calculate a weighted weight for each historical usage record according to time recency and recognition confidence, calculate a prior probability according to historical weighted strength of each spool category, and calculate the fusion weight by multiplying and normalizing the prior probability and category confidence output by the server side:

$${β}_{i} = \frac{{p}_{i}^{γ} \cdot {q}_{i}^{δ}}{{\sum }_{i = 1}^{N} {p}_{j}^{γ} \cdot {q}_{j}^{δ}}$$

where qᵢ represents the prior probability of the i-th spool category, pᵢ represents category confidence corresponding to the i-th spool category, and γ and δ represent preset weight adjustment parameters.

In one embodiment, the net-weight calculation module includes a compensation calculation unit. The compensation calculation unit is configured to query the additional structure compensation weight corresponding to the spool category and obtain the recognition confidence corresponding to the category identifier synchronously output by the server side, and calculate the net-weight result by using the following formula:

$${W}_{net}^{⋆} = {W}_{total} - {W}_{tare} - {W}_{extra} + α$$

where Wₜₐᵣₑ represents the tare data, Wₑₓₜᵣₐ represents the additional structure compensation weight, and α represents the correction parameter. The correction parameter includes at least one of a weighing-stability correction term, an environmental compensation term, and a recognition-confidence correction term, and the recognition-confidence correction term has an inverse relationship with the recognition confidence.

In one embodiment, the system further includes a mode switching module. The mode switching module is configured to lock the spool mode after the target object is determined to be a spool object while the current target object remains stable; release the mode lock and perform stability analysis again when it is detected that the target object is removed from the weighing platform or the variation amount of the weight data exceeds the preset variation threshold; and automatically fall back to the ordinary weighing mode and directly output the weight data when server-side recognition fails or network communication is abnormal.

The modules in the automatic tare-removal and net-weight calculation system based on visual recognition may be implemented entirely or partially by software, hardware, or a combination thereof. The modules may be embedded in or independent of a processor of a computer device in hardware form, or may be stored in a memory of the computer device in software form so that the processor calls and executes operations corresponding to the modules.

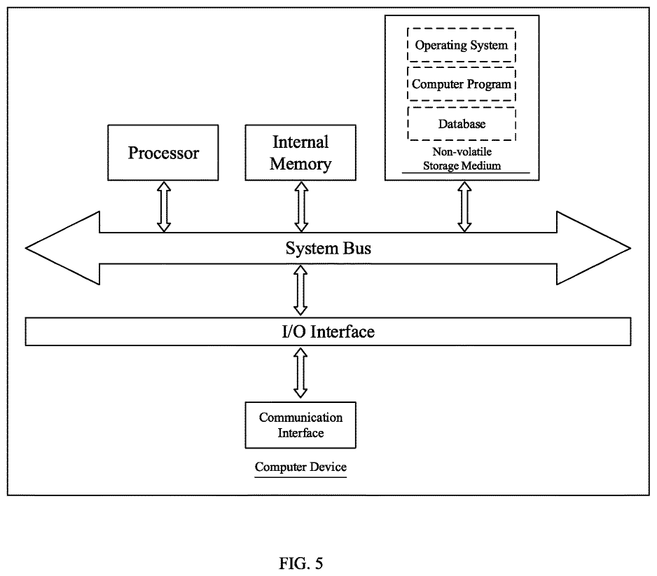

In one embodiment, a computer device is provided. The computer device may be a server, and its internal structure may be as shown in FIG. 5. The computer device includes a processor, a memory, and a network interface connected by a system bus. The processor is configured to provide computing and control capabilities. The memory may include a nonvolatile storage medium and an internal memory. The nonvolatile storage medium stores an operating system, a computer program, and a database. The internal memory provides an environment for running the operating system and the computer program in the nonvolatile storage medium. The database may store the spool tare database, historical usage records, image samples, and model parameters. The network interface is configured to communicate with an external terminal through a network. When the computer program is executed by the processor, the processor implements the above automatic tare-removal and net-weight calculation method based on visual recognition.

A person skilled in the art may understand that the structure shown in FIG. 5 is merely a block diagram of part of the structure related to the solution of the present disclosure and does not constitute a limitation on the computer device to which the solution is applied. A specific computer device may include more or fewer components than those shown, may combine some components, or may have a different component arrangement.

In a third aspect, a computer device is provided. The computer device includes a memory and a processor, the memory stores a computer program, and the processor, when executing the computer program, implements any method step in the above method embodiments.

In a fourth aspect, a non-transitory computer-readable storage medium is provided. The computer-readable storage medium stores a computer program, and the computer program, when executed by a processor, implements any method step in the above method embodiments.

A person of ordinary skill in the art may understand that all or part of the processes in the method embodiments may be implemented by a computer program instructing related hardware. The computer program may be stored in a nonvolatile computer-readable storage medium. When executed, the computer program may include the processes of the method embodiments described above. The storage medium may be a magnetic disk, an optical disk, a read-only memory, a random-access memory, or the like.

The technical features of the above embodiments may be combined in any suitable manner. For concise description, not all possible combinations of the technical features in the above embodiments are described. However, as long as there is no contradiction among the combinations of the technical features, such combinations should be considered as being within the scope described in the specification.

The embodiments described above merely express several implementations of the present disclosure. Although the description is relatively specific and detailed, it should not be construed as limiting the patent scope of the present disclosure. It should be noted that a person of ordinary skill in the art may make various modifications and improvements without departing from the concept of the present disclosure, and such modifications and improvements all fall within the protection scope of the present disclosure. Therefore, the patent protection scope of the present disclosure shall be subject to the appended claims.

What is claimed is:

1. An automatic tare-removal and net-weight calculation method based on visual recognition, comprising: acquiring weight data of a target object; performing stability analysis on the weight data and generating a trigger signal when the weight data is determined to be in a stable state; acquiring an image of the target object in response to the trigger signal; performing local mode recognition on the acquired image to determine whether the target object is a spool object; when the target object is determined to be the spool object, uploading the image to a server side, so that the server side performs spool category recognition and obtains a corresponding category identifier; when the target object is determined to be an ordinary object, directly outputting the weight data as a weighing result; querying tare data corresponding to the category identifier in a spool database; calculating a net-weight result according to the weight data and the tare data; and outputting and displaying the net-weight result.

2. The method of claim 1, wherein performing the stability analysis on the weight data comprises: collecting a plurality of consecutive sampling points of the weight data by using a sliding window; calculating a peak-to-peak value of the weight data in the sliding window and a deviation between a latest sampling point in the sliding window and an average value of remaining sampling points in the sliding window; and determining that the weight data is in the stable state when the peak-to-peak value is less than a preset peak-to-peak threshold and the deviation is less than a preset deviation threshold.

3. The method of claim 1, wherein performing the local mode recognition on the acquired image comprises: inputting the acquired image into a lightweight convolutional neural network model to obtain a probability value that the target object is the spool object; comparing the probability value with a preset high threshold and a preset low threshold; determining that the target object is the spool object when the probability value is greater than or equal to the preset high threshold; determining that the target object is the ordinary object when the probability value is less than or equal to the preset low threshold; and, when the probability value is between the preset low threshold and the preset high threshold, continuously acquiring a plurality of frames of images, respectively inputting the plurality of frames of images into the lightweight convolutional neural network model, comparing an average value of probability values output from the plurality of frames with the preset high threshold and the preset low threshold, and uploading the image to the server side when the average value remains between the preset low threshold and the preset high threshold.

4. The method of claim 1, wherein calculating the net-weight result according to the weight data and the tare data comprises: receiving, from the server side, a recognition confidence corresponding to the category identifier; when a highest recognition confidence output by the server side is lower than a preset confidence threshold, receiving a plurality of candidate categories and a corresponding probability distribution returned by the server side; querying, in the spool database, tare data corresponding to each of the plurality of candidate categories; and calculating the net-weight result by using the following weighted fusion model:
$${W}_{net} = {W}_{total} - {\sum }_{i = 1}^{N} {β}_{i} \cdot {W}_{tare , i}$$
where Wₙₑₜ represents the net-weight result, Wₜₒₜₐₗ represents the weight data, N represents a number of candidate categories, W_{tare,i} represents tare data of an i-th candidate category, and βᵢ represents a fusion weight of the i-th candidate category, the fusion weights satisfying a normalization condition.

5. The method of claim 4, wherein determining the fusion weight comprises: constructing a prior probability model based on user historical usage records, the user historical usage records comprising spool categories historically used by a user and occurrence frequencies of the spool categories; calculating a weighted weight for each of the user historical usage records according to time recency and the recognition confidence; calculating a prior probability according to historical weighted strength of each spool category; and calculating the fusion weight by multiplying and normalizing the prior probability and category confidence output by the server side according to the following formula:
$${β}_{i} = \frac{{p}_{i}^{γ} \cdot {q}_{i}^{δ}}{{\sum }_{i = 1}^{N} {p}_{j}^{γ} \cdot {q}_{j}^{δ}}$$
where qᵢ represents the prior probability of the i-th spool category, pᵢ represents category confidence corresponding to the i-th spool category, and γ and δ represent preset weight adjustment parameters.

6. The method of claim 1, wherein calculating the net-weight result according to the weight data and the tare data comprises: querying an additional structure compensation weight corresponding to a spool category; obtaining the recognition confidence corresponding to the category identifier synchronously output when the server side performs the spool category recognition; and calculating the net-weight result by using the following formula:
$${W}_{net}^{⋆} = {W}_{total} - {W}_{tare} - {W}_{extra} + α$$
where Wₜₐᵣₑ represents the tare data, Wₑₓₜᵣₐ represents the additional structure compensation weight, and α represents the correction parameter. The correction parameter includes at least one of a weighing-stability correction term, an environmental compensation term, and a recognition-confidence correction term, and the recognition-confidence correction term has an inverse relationship with the recognition confidence. Wₜₐᵣₑ and Wₑₓₜᵣₐ are not double-counted; if Wₜₐᵣₑ includes additional structure, Wₑₓₜᵣₐ is set to zero

7. The method of claim 1, further comprising: after the target object is determined to be the spool object, locking a spool mode while a current target object remains stable; when it is detected that the target object is removed from a weighing platform or a variation amount of the weight data exceeds a preset variation threshold, releasing the spool mode and performing the stability analysis on the weight data again; and when server-side recognition fails or network communication is abnormal, automatically falling back to an ordinary weighing mode and directly outputting the weight data.

8. An automatic tare-removal and net-weight calculation system based on visual recognition, comprising: a data acquisition module configured to acquire weight data of a target object, perform stability analysis on the weight data, and generate a trigger signal when the weight data is determined to be in a stable state; an image acquisition module configured to acquire an image of the target object in response to the trigger signal; a local mode recognition module configured to perform local mode recognition on the acquired image to determine whether the target object is a spool object, upload the image to a server side when the target object is determined to be the spool object so that the server side performs spool category recognition and obtains a corresponding category identifier, and directly output the weight data as a weighing result when the target object is determined to be an ordinary object; a net-weight calculation module configured to query tare data corresponding to the category identifier in a spool database and calculate a net-weight result according to the weight data and the tare data; and an output display module configured to output and display the net-weight result.

9. A computer device, comprising a memory and a processor, wherein the memory stores a computer program, and the processor, when executing the computer program, implements the automatic tare-removal and net-weight calculation method based on visual recognition according to claim 1.

10. A non-transitory computer-readable storage medium having a computer program stored thereon, wherein the computer program, when executed by a processor, causes the processor to implement the automatic tare-removal and net-weight calculation method based on visual recognition according to claim 1.
